(19) United States
(12) Patent Application Publication
(10) Pub. No.: US 2024/0351879 A1
(43) Pub. Date: Oct. 24, 2024

(54) PROCESS AND APPARATUS FOR PREPARING SULFUR TRIOXIDE FROM SULFUR DIOXIDE

(71) Applicant: Messer Industries USA, Inc., Bridgewater, NJ (US)

(72) Inventors: Guisu Liu, Naperville, IL (US); Blake Stapper, Austin, TX (US)

(73) Assignee: Messer Industries USA, Inc., Bridgewater, NJ (US)

(21) Appl. No.: 18/136,912

(22) Filed: Apr. 20, 2023

(51) Int. Cl. C01B 17/80; C01B 17/765

(52) U.S. Cl. CPC C01B 17/803; C01B 17/765; C01B 17/806

(57) ABSTRACT

A process for the catalytic conversion of sulfur dioxide to sulfur trioxide to increase sulfuric acid regeneration from a spent sulfuric acid stream or other sulfur-containing stream includes replacing at least a portion of the atmospheric air typically used to oxidize sulfur dioxide to sulfur trioxide with oxygen by introducing oxygen-enriched air and/or pure oxygen feed streams into the process. A related apparatus for use in the process is also provided for catalytic conversion of sulfur dioxide to sulfur trioxide.

### TECHNICAL FIELD

The present embodiments relate to a process and apparatus for producing sulfuric acid. Illustrative embodiments relate to a process and apparatus for preparing sulfur trioxide from a stream containing sulfur dioxide.

### BACKGROUND OF THE INVENTION

A sulfuric acid regeneration plant oxidizes sulfur-containing feed streams in a furnace to produce a process gas that consists primarily of sulfur dioxide, which is subsequently routed through heat recovery and gas conditioning equipment.

After the sulfur-containing process gas exits the gas conditioning equipment, it primarily consists of dry, low-temperature sulfur dioxide. Known processes mix ambient air (such as for example atmospheric air) or dry air with the sulfur dioxide-containing process gas to allow sulfur dioxide to be fully oxidized to sulfur trioxide as the gas passes across one or more catalyst beds in a catalytic converter.

The mixture of gas containing sulfur dioxide and atmospheric air must be maintained at a temperature that is adequate to promote the oxidation reaction prior to entering each bed of the catalytic converter. The temperature of the mixture may be adjusted by an exchange of heat. The heat exchanger may be limited in capacity and so an attempt to increase production causes the final temperature of the mixture to be unable to properly promote the oxidation reaction necessary to produce sulfur trioxide.

Increasing the volumetric gas flow rate of the gas mixture entering the catalytic converter has two additional negative impacts on the process. First, it increases the pressure drop across the catalyst and in many cases the process is already limited by fan capacity. Second, the increased volumetric flow rate lowers the residence time in the catalytic converter which lowers the conversion efficiency and leads to higher amounts of unreacted sulfur dioxide exiting the converter and being emitted to the atmosphere.

The oxidation of sulfur dioxide in the converter is an exothermic reaction and therefore, increasing the amount of sulfur dioxide entering the converter will result in more heat being generated. A more recent catalytic converter is typically divided into multiple stages so that heat can be removed between each catalytic stage to maintain the proper reaction temperature range at each stage. The gases first pass through the catalyst bed and are then ducted through a heat exchanger to reduce the temperature before they return to pass through the next catalyst bed. Older versions of catalytic converters may include only a single catalyst bed and no heat exchanger to regulate the temperature of an outlet gas stream.

A sulfuric acid plant equipment train that is operating at design capacity is limited by multiple operating constraints, including the pressure drop created by the gases moving through the system and the capacity of the system to maintain the temperature of the gases at the optimum levels to promote the reactions. Furthermore, if the amount of sulfur dioxide being introduced into the catalytic converter increases, the capacity of the heat exchangers may not be sufficient to remove the additional heat that is generated, whereupon the resulting increased temperature of the process gas in the converter will limit the completeness of the reaction to sulfur trioxide based on equilibrium of sulfur trioxide formation and decomposition.

### SUMMARY OF THE INVENTION

Disclosed herein is a process for replacing at least a portion of the oxidizing atmospheric air with oxygen that is mixed with a sulfur dioxide-containing feed for oxidation to produce sulfur trioxide in a catalytic converter. The process may include mixing the oxygen with the sulfur dioxide stream prior to entering the initial catalytic region or stage of the catalytic converter, and/or mixing the oxygen with the sulfur dioxide stream prior to introducing the sulfur dioxide stream to subsequent catalytic regions or stages of the catalytic converter.

According to an illustrative embodiment of the present invention, provided is a process for converting sulfur dioxide to sulfur trioxide, the process including (a) introducing a sulfur dioxide feed stream into a catalytic converter for converting sulfur dioxide to sulfur trioxide, (b) introducing an oxygen-enriched feed stream, a pure oxygen feed stream, or both the oxygen-enriched feed stream and the pure oxygen feed stream into the catalytic converter, and (c) catalytically oxidizing at least a portion of the sulfur dioxide from the sulfur dioxide feed stream for producing sulfur trioxide.

According to another illustrative embodiment of the present invention, provided is an apparatus for converting sulfur dioxide to sulfur trioxide, the apparatus including a housing, an inlet for the housing for supplying a sulfur dioxide-containing feed into the housing, at least one catalytic region positioned in the housing for converting sulfur dioxide to sulfur trioxide, and at least one inlet for supplying a feed stream of an oxygen-enriched combustion air or a feed stream of pure oxygen into the sulfur dioxide-containing feed.

The Summary of the Invention above is intended as a brief introduction to certain illustrative embodiments of the invention and should not be considered to limit the scope of the appended claims in any manner whatsoever.

### BRIEF DESCRIPTION OF THE DRAWINGS

For a more complete understanding of the present invention, reference may be had to the following description of exemplary embodiments considered in connection with the accompanying drawing Figures, of which:

FIG. 1 is a schematic representation of a known sulfuric acid production plant having a catalytic converter for converting sulfur dioxide from a feed stream into sulfur trioxide.

FIG. 2 is a schematic representation of a known multiple stage catalytic converter part of the sulfuric acid production plant for converting sulfur dioxide from a feed stream into sulfur trioxide shown in FIG. 1.

FIG. 3 is a schematic representation of an illustrative embodiment of the presently disclosed multiple stage catalytic converter for converting sulfur dioxide from a feed stream into sulfur trioxide.

FIG. 4 is a schematic representation of another illustrative embodiment of the presently disclosed multiple stage catalytic converter for converting sulfur dioxide from a feed stream into sulfur trioxide.

FIG. 5 is a schematic representation of another illustrative embodiment of the presently disclosed multiple stage catalytic converter for converting sulfur dioxide from a feed stream into sulfur trioxide.

### DETAILED DESCRIPTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

Reference in the following description to “one or more” may be considered to include “one or a plurality of”. Reference in the following description to “ambient air” may include for example “atmospheric air” or “dry air”.

References in the following description to “inlet” and “outlet” are with respect to fluid communication or movement of a substance or fluid (liquid or gas) into a structure and out of the structure, respectively. Such inlet and/or outlet can be accomplished with openings, ports, orifices, pipes, conduits, spillways, or with other similar types of structures such as for example injectors or spargers.

The description contained herein that refers to at least one catalytic region or stage with one or more heat exchangers is not intended to exclude the older single catalyst bed version that does not include a heat exchanger.

Disclosed is a process and an apparatus for converting sulfur dioxide to sulfur trioxide. The process and apparatus utilizes oxygen to replace some or all of the atmospheric air that is mixed with the sulfur dioxide stream for oxidation to sulfur trioxide in the catalytic converter.

The replacement of at least a portion of the atmospheric air with oxygen maintains or reduces the total volume of the gas mixture which allows the processing of more sulfur dioxide with the same amount of pressure drop and residence time, while also maintaining the ability of the heat exchangers of the catalytic converter to lower the temperature to what is required to promote the oxidation reaction of sulfur dioxide to sulfur trioxide in the catalytic converter.

The replacement of at least a portion of the atmospheric air with oxygen also increases the partial pressure of oxygen and sulfur dioxide and promotes the rate of the conversion of sulfur dioxide to sulfur trioxide across the catalyst in the catalytic region of the catalytic converter.

At least a portion of the oxygen replacement may be introduced into suitable ducting or piping prior to entering the housing of the catalytic converter to ensure proper mixing with the remaining atmospheric air and the sulfur dioxide prior to coming into contact with the catalyst in the initial catalytic stage or region of the converter. The process also provides for withholding all or a portion of the oxygen replacement from the initial catalyst region or stage and mixing it with the sulfur dioxide gas stream prior to entering catalyst stages or regions that are positioned downstream from the initial catalyst stage or region.

The oxygen introduced to the initial catalyst stage or region is controlled to manage the amount of heat that is released by the exothermic sulfur dioxide oxidation reaction. The remaining oxygen replacement may then be introduced into the process gas stream in subsequent stages of the converter, downstream of the heat exchanger and prior to entering subsequent catalyst stages for the purpose of managing the temperature of the gas and maintaining the proper reaction temperature in that stage of the converter.

The process increases the capacity of the catalytic converter in a sulfuric acid plant by the replacement of some or all of the oxidizing air with oxygen, while the conversion and energy efficiency are maintained. The process for converting sulfur dioxide to sulfur trioxide comprises introducing a sulfur dioxide feed stream into a catalytic converter for converting sulfur dioxide to sulfur trioxide, introducing an oxygen-enriched feed stream, a pure oxygen feed stream, or both an oxygen-enriched feed stream and a pure oxygen feed stream to the catalytic converter and oxidizing at least a portion of the sulfur dioxide from the sulfur dioxide feed stream to produce sulfur trioxide.

According to certain illustrative embodiments, the process comprises adding an oxygen-enriched feed stream to the catalytic converter. According to other illustrative embodiments, the process comprises adding a pure oxygen feed stream to the catalytic converter. According to further illustrative embodiments, the process comprises adding both an oxygen-enriched feed stream and a pure oxygen feed stream to the catalytic converter.

The process of converting sulfur dioxide to sulfur trioxide utilizes a catalytic converter. The catalytic converter utilized in the process comprises a housing having at least one catalytic region positioned within the housing that is capable of catalytically oxidizing at least a portion of the sulfur dioxide of the sulfur dioxide feed stream that is introduced into the catalytic converter. The catalytic converter also comprises at least one heat exchanger for removing heat energy from the stream that is generated during the process of converting the sulfur dioxide to sulfur trioxide.

According to certain illustrative embodiments, the catalytic converter utilized in the process of converting sulfur dioxide to sulfur trioxide comprises a housing having more than one catalytic region (or a plurality of catalytic regions) positioned within the housing, each region of which is capable of catalytically oxidizing at least a portion of the sulfur dioxide of the sulfur dioxide feed stream introduced into the catalytic converter and into one or more heat exchangers for removing heat energy generated as a result of the conversion process in the catalytic converter. The catalytic converter includes an upstream sulfur dioxide-containing feed stream inlet for introducing the sulfur dioxide-containing feed stream into the housing of the catalytic converter for catalytic conversion to sulfur trioxide and a downstream sulfur trioxide-containing stream outlet where the sulfur trioxide-containing stream exits the catalytic converter housing.

According to certain illustrative embodiments, the one or more heat exchangers may be positioned within the housing of the catalytic converter. According to other illustrative embodiments, the one or more heat exchangers may be positioned external to the housing of the catalytic converter. According to further illustrative embodiments, at least one of the one or more heat exchangers are positioned within the housing of the catalytic converter and at least one of the of the one or more heat exchangers are positioned external to the housing of the catalytic converter. The one or more catalytic regions are in fluid communication with the one or more exchangers by suitable fluid connections such as, without limitation, ducting, conduit, hosing, piping, tubing and like fluid connections.

According to certain non-limiting illustrative embodiments, the catalytic converter used in the process of converting sulfur dioxide to sulfur trioxide comprises an elongated vessel having an upstream sulfur dioxide-containing feed stream inlet located at a first end of the housing for introducing the sulfur dioxide-containing feed stream into the housing of the catalytic converter for catalytic conversion to sulfur trioxide, a downstream sulfur trioxide-containing stream outlet located at another end of the housing, such as for example an opposite end of the housing, where the sulfur trioxide-containing stream exits the catalytic converter housing and a length defined between the inlet and the outlet. The catalytic converter may include more than one catalytic region and one or a plurality of heat exchangers positioned along the length of the housing between the inlet and the outlet of the housing. According to certain embodiments, the more than one catalytic regions and the one or more heat exchangers may be arranged in an alternating pattern along the length of the housing of the catalytic converter.

The process for converting sulfur dioxide to sulfur trioxide comprises introducing an oxygen-enriched feed stream, a pure oxygen feed stream, or both an oxygen-enriched feed stream and a pure oxygen feed stream into the catalytic converter at least at the inlet position along a length of the catalytic converter. According to certain embodiments, the process for converting sulfur dioxide to sulfur trioxide comprises introducing an oxygen-enriched feed stream, a pure oxygen feed stream, or both an oxygen-enriched feed stream and a pure oxygen feed stream into the catalytic converter at a position upstream of a first catalytic region of the catalytic converter. According to illustrative embodiments, the oxygen-enriched feed stream, pure oxygen feed stream, or both the oxygen-enriched feed stream and the pure oxygen feed stream may be introduced into the catalytic converter housing through the sulfur dioxide containing feed stream inlet that is positioned upstream of the housing of the catalytic converter. This may be accomplished by introducing the oxygen-enriched feed stream and/or pure oxygen feed stream into the sulfur dioxide-containing feed stream at a position upstream of the sulfur dioxide-containing inlet of the housing of the catalytic converter. The mixture of the sulfur dioxide-containing feed stream and oxygen-enriched feed stream and/or pure oxygen feed stream then enters the housing of the catalytic converter through the inlet.

According to other illustrative embodiments, the oxygen-enriched feed stream, pure oxygen feed stream, or both the oxygen-enriched feed stream and the pure oxygen feed stream may be introduced directly into the catalytic converter housing through at least one inlet that is positioned in a side wall of the housing along the length of the catalytic converter.

According to certain illustrative embodiments, the process of converting sulfur dioxide to sulfur trioxide comprises introducing the oxygen-enriched feed stream, pure oxygen feed stream, or both the oxygen-enriched feed stream and pure oxygen feed stream into the catalytic converter through at least one inlet that is positioned in the side wall of the housing at a position that is located upstream of the one or more heat exchangers.

According to certain illustrative embodiments, the process of converting sulfur dioxide to sulfur trioxide comprises introducing the oxygen-enriched feed stream, pure oxygen feed stream, or both the oxygen-enriched feed stream and pure oxygen feed stream into the catalytic converter through at least one inlet that is positioned in the side wall of the housing at a position that is located downstream of the one or more heat exchangers.

According to certain embodiments, the process for converting sulfur dioxide to sulfur trioxide comprises supplying at least one of a spent sulfuric acid stream or the other sulfur-containing stream to a furnace, decomposing the spent sulfuric acid stream or other sulfur-containing stream in the furnace to form sulfur dioxide, introducing a sulfur dioxide feed stream into a catalytic converter for converting sulfur dioxide to sulfur trioxide, and catalytically oxidizing at least a portion of the sulfur dioxide from the sulfur dioxide feed stream to sulfur trioxide. The process for catalytically oxidizing the sulfur dioxide to sulfur trioxide is carried out by any of the illustrative embodiments described herein.

Also disclosed is a process for preparing sulfuric acid from at least one of a spent sulfuric acid stream or other sulfur-containing stream. The process comprises supplying at least one of a spent sulfuric acid stream or other sulfur-containing stream into a furnace, decomposing the at least one spent sulfuric acid stream or other sulfur-containing stream in the furnace to form sulfur dioxide, introducing a sulfur dioxide feed stream into a catalytic converter for converting sulfur dioxide to sulfur trioxide, catalytically oxidizing at least a portion of the sulfur dioxide from the sulfur dioxide feed stream to sulfur trioxide, and converting the sulfur trioxide to sulfuric acid. The process for catalytically oxidizing the sulfur dioxide to sulfur trioxide is carried out by any of the illustrative embodiments described herein.

Also disclosed herein is an apparatus for use in the process for converting sulfur dioxide to sulfur trioxide. The apparatus comprises a housing, at least one catalytic region for converting sulfur dioxide to sulfur trioxide positioned within the housing, at least one heat exchanger, and at least one inlet for supplying a feed stream of an oxygen-enriched combustion air or a feed stream of pure oxygen into the housing. According to certain embodiments, the one or more inlets for supplying the feed stream of oxygen-enriched combustion air and/or feed stream of pure oxygen into the housing are positioned upstream from a first catalytic region of the housing. These one or more inlets may be orifices located in the side walls of the housing of the catalytic converter. Alternatively, the one or more inlets for supplying the feed stream with oxygen-enriched combustion air and/or feed stream of pure oxygen into the housing are positioned upstream in fluid communication with the sulfur dioxide containing feed stream inlet that is positioned upstream of the housing of the catalytic converter. The oxygen-enriched feed stream and/or pure oxygen feed stream sources are in fluid communication with piping carrying the sulfur dioxide-containing feed stream at a position upstream of the sulfur dioxide-containing inlet of the housing of the catalytic converter.

According to certain embodiments, the one or more inlets for supplying the feed stream of oxygen-enriched combustion air and/or feed stream of pure oxygen into the housing are positioned in the side wall of the housing at a position located upstream of one heat exchanger of the one or more heat exchangers. According to certain embodiments, the one or more inlets for supplying the feed stream of oxygen-enriched combustion air and/or feed stream of pure oxygen into the housing are positioned in the side wall of the housing at positions located upstream of each of the one or more heat exchangers.

According to certain embodiments, the one or more inlets for supplying the feed stream of oxygen-enriched combustion air and/or feed stream of pure oxygen into the housing are positioned in the side wall of the housing at a position located upstream of one heat exchanger of the one or more heat exchangers. According to certain embodiments, the one or more inlets for supplying the feed stream of oxygen-enriched combustion air and/or feed stream of pure oxygen into the housing are positioned in the side wall of the housing at positions located downstream of each of the one more heat exchangers.

The apparatus that is used in the disclosed process of regenerating sulfuric acid from a sulfur-containing feed stream includes a furnace to oxidize sulfur-containing feedstock to sulfur dioxide, a gas conditioning system to remove moisture and other impurities, a catalytic converter to oxidize the sulfur dioxide to sulfur trioxide, and an acid tower in which the sulfur trioxide is absorbed into recycled acid.

The sulfuric acid regeneration apparatus includes a decomposition furnace positioned upstream from the catalytic converter. The decomposition furnace comprises an inlet for supplying at least one of a spent sulfuric acid stream or other sulfur-containing stream into the decomposition furnace, an inlet for supplying at least one of a feed stream of combustion air, a feed stream of an oxygen-enriched combustion air, or a feed stream of pure oxygen, into the decomposition furnace, an inlet for supplying a combustion fuel stream to the decomposition furnace, and outlet for a sulfur dioxide-containing stream. The catalytic converter is in fluid communication with the outlet of the decomposition furnace to receive a gas stream containing sulfur dioxide for conversion to sulfur trioxide. A conditioning vessel may be positioned between the decomposition furnace and the catalytic converter for receiving the sulfur dioxide stream exiting the furnace to remove moisture and impurities from the stream. The inlet end of the conditioning vessel is in fluid communication with the outlet end of the decomposition furnace, while the outlet end of the conditioning vessel is in fluid communication with an inlet end of the catalytic converter. A sulfuric acid absorption vessel may be positioned downstream from and in fluid communication with the catalytic converter. The inlet end of the sulfuric acid absorption vessel is in fluid communication with the outlet end of the catalytic converter for the purpose of receiving a gas stream containing sulfur trioxide.

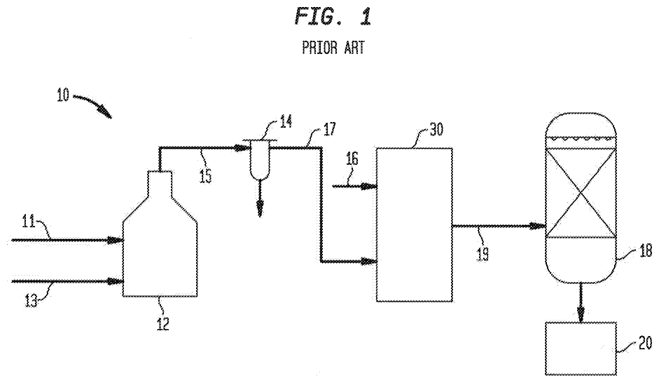

FIG. 1 shows a schematic of a known sulfuric acid regeneration plant 10. Sulfuric acid regeneration plant 10 includes decomposition furnace 12, feed conditioning chamber 14, catalytic converter 30, absorption tower 18 or vessel, and collection chamber 20 for regenerated sulfuric acid. A spent sulfuric acid feed or other sulfur-containing feed 11 and atmospheric air feed 13 are injected into decomposition furnace 12. Conditioning chamber 14 is positioned between the decomposition furnace 12 and the catalytic converter 30 for receiving the sulfur dioxide stream 15 exiting the furnace 12 to remove moisture and impurities from the stream 15. The conditioning chamber 14 may be optional, and when used will also purify the sulfur dioxide stream 15. Catalytic converter 30 receives the conditioned sulfur dioxide stream 17 exiting the conditioning chamber 14, while a dry air stream 16 is also provided to the catalytic converter 30. The absorption vessel 18 is positioned downstream from the catalytic converter 30. An inlet end of the absorption vessel 18 is in fluid communication with the outlet end of the catalytic converter 30 for the purpose of receiving a gas stream 19 containing sulfur trioxide. The regenerated sulfuric acid is collected in the collection chamber 20.

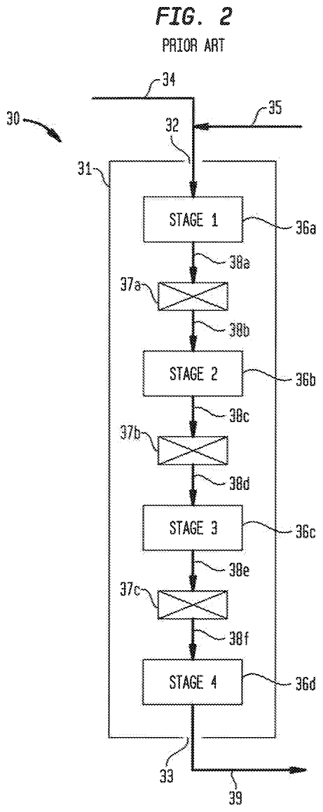

FIG. 2 shows a schematic of a known multiple stage catalytic converter 30 for converting sulfur dioxide to sulfur trioxide. Catalytic converter 30 includes an elongated housing 31 having an upstream inlet end 32 and a downstream outlet end 33. A sulfur dioxide-containing gas stream (17, FIG. 1) is delivered to catalytic converter 30 through pipe 34 that is in fluid communication with inlet 32. Oxidizing atmospheric air stream (16, FIG. 1) is delivered to catalytic converter 30 through pipe 35 that is in fluid communication with inlet 32. Catalytic converter 30 includes a plurality of catalyst regions or stages 36a-36d that include catalyst suitable for catalytically oxidizing at least a portion of the sulfur dioxide-containing feed that is delivered through a pipe 34 to the catalytic converter. Catalytic converter 30 also includes a plurality of heat exchangers 37a-37c for removing heat energy generated during the oxidation process of sulfur dioxide to sulfur trioxide. Catalytic converter 30 also includes a plurality of pipes 38a-38f for fluidly connecting the plurality of catalytic regions 36a-36d and the plurality of heat exchangers 37a-37c. The gas stream containing sulfur trioxide exits the catalytic converter 30 at the outlet 33 through pipe 39.

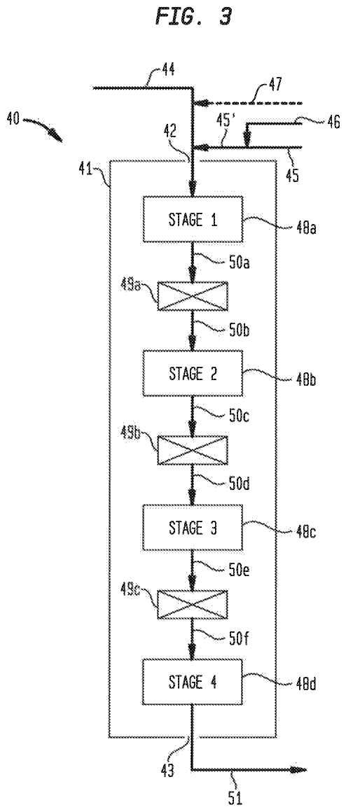

FIG. 3 shows a schematic of an illustrative embodiment of the presently disclosed multiple stage catalytic converter 40 for converting sulfur dioxide to sulfur trioxide. Catalytic converter 40 includes an elongated housing 41 having an upstream inlet end 42 and a downstream outlet end 43. A sulfur dioxide-containing gas stream is delivered to catalytic converter 40 through pipe 44 that is in fluid communication with inlet 42. A stream of oxidizing atmospheric air is delivered through pipe 45 to pipe 44, the pipe 44 supplying the sulfur dioxide-containing stream to catalytic converter 40. Pure oxygen is supplied via pipe 46 to the oxidizing atmospheric air in the pipe 45. Accordingly, downstream of where the pipe 46 is in fluid communication with or tied into the pipe 45 there is provided oxygen-enriched oxidizing air in a portion 45′ of the pipe 45. Additionally, or alternatively, to the delivery of oxygen-enriched oxidizing air via the pipe portion 45′, a stream of pure oxygen can be supplied via pipe 47 to the pipe 44. The result is that a portion of the atmospheric air in pipe 45 is replaced with oxygen delivered from pipes 46 and/or 47. Catalytic converter 40 includes a plurality of catalyst regions or stages 48a-48d that include catalyst suitable for catalytically oxidizing at least portion of the sulfur dioxide-containing feed delivered to catalyst converter by pipe 44. Catalytic converter 40 also includes a plurality of heat exchangers 49a-49c for removing heat energy generated during the oxidation process of sulfur dioxide to sulfur trioxide. Catalytic converter 40 also includes a plurality of pipes 50a-50f for fluidly connecting the plurality of catalytic regions 48a-48d and the plurality of heat exchangers 49a-49c. The gas stream containing sulfur trioxide exits the catalytic converter 40 at outlet 43 through pipe 51.

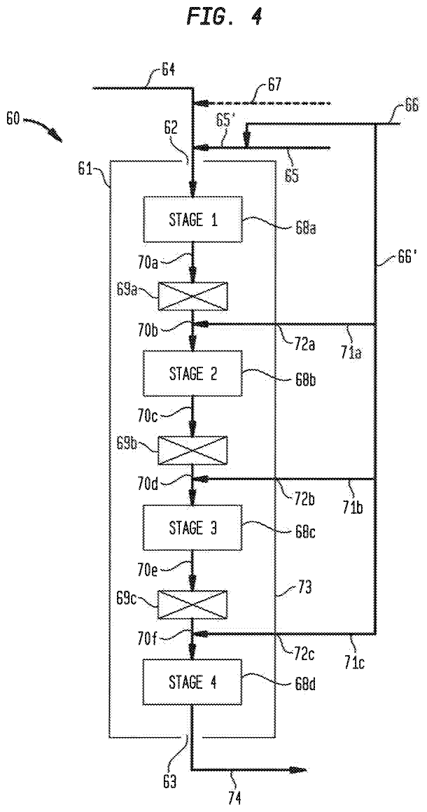

FIG. 4 shows a schematic of another illustrative embodiment of the presently disclosed multiple stage catalytic converter 60 for converting sulfur dioxide to sulfur trioxide. Catalytic converter 60 includes an elongated housing 61 having an upstream inlet end 62 and a downstream outlet end 63. A sulfur dioxide-containing gas stream is delivered to catalytic converter 60 through pipe 64 that is in fluid communication with inlet 62. A stream of oxidizing atmospheric air is delivered through pipe 65 to pipe 64, the pipe 64 supplying the sulfur dioxide-containing stream to catalytic converter 60. Pure oxygen is supplied via pipe 66 to the oxidizing atmospheric air in pipe 65. Accordingly, downstream of where the pipe 66 is in fluid communication with or tied into the pipe 65 there is provided oxygen-enriched oxidizing air in a portion 65′ of the pipe 65. Additionally, or alternatively, to the delivery of oxygen-enriched oxidizing air via the pipe portion 65′, a stream of pure oxygen can be supplied via pipe 67 to pipe 64. The result is that a portion of the atmospheric air in pipe 65 is replaced with oxygen delivered from pipes 66 and/or 67. Catalytic converter 60 includes a plurality of catalyst regions or stages 68a-68d that include catalyst suitable for catalytically oxidizing at least portion of the sulfur dioxide-containing feed delivered to catalyst converter by pipe 64. Catalytic converter 60 also includes a plurality of heat exchangers 69a-69c for removing heat energy generated during the oxidation process of sulfur dioxide to sulfur trioxide. Catalytic converter 60 also includes a plurality of pipes 70a-70f for fluidly connecting the plurality of catalytic regions 68a-68d and the plurality of heat exchangers 69a-69c. Catalytic converter 60 further includes a branch 66′ or pipe extending from and in fluid communication with the pipe 66. A plurality of pipes 71a-71c or inlets are in fluid communication with the branch 66′ and the pipes 70b, 70d, 70f, respectively, via orifices 72a-72c, respectively, located in a side wall 73 of the catalytic converter 60. Oxygen-enriched atmospheric oxidizing air and/or pure oxygen is delivered to pipes 70b, 70d, 70f in the housing 61 of the catalytic converter 60 via pipes 71a-71c that extend through the side wall 73 downstream of each of the heat exchangers 69a-69c, respectively. The gas stream containing sulfur trioxide exits the catalytic converter 60 at outlet 63 through pipe 74.

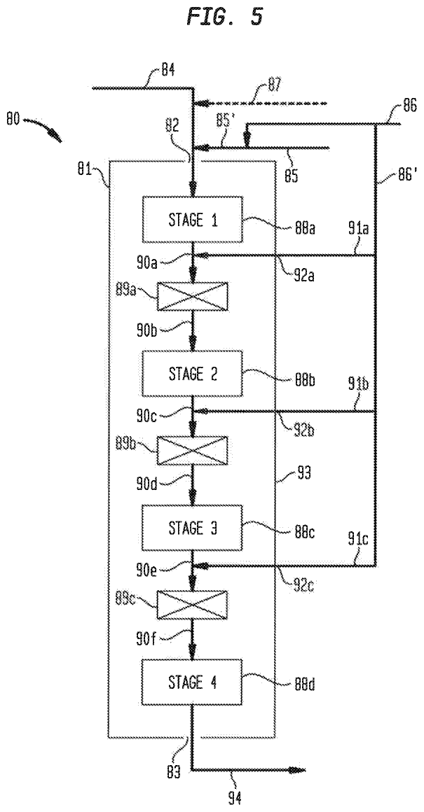

FIG. 5 shows a schematic of another illustrative embodiment of the presently disclosed multiple stage catalytic converter 80 for converting sulfur dioxide to sulfur trioxide. Catalytic converter 80 includes an elongated housing 81 having an upstream inlet end 82 and a downstream outlet end 83. A sulfur dioxide-containing gas stream is delivered to catalytic converter 80 through pipe 84 that is in fluid communication with inlet 82. A stream of oxygen-enriched oxidizing air is delivered through pipe 85 to pipe 84, the pipe 84 supplying the sulfur dioxide-containing stream to catalytic converter 80. Pure oxygen is supplied via pipe 86 to the oxidizing atmospheric air in pipe 85. Accordingly, downstream of where the pipe 86 is in fluid communication with or tied into the pipe 85 there is provided oxygen-enriched oxidizing air in a portion 85′ of the pipe 85. Additionally, or alternatively, to the delivery of oxygen-enriched oxidizing air via the pipe portion 85′, a stream of pure oxygen can be supplied via pipe 87 to pipe 84. The result is that a portion of the atmospheric air in pipe 85 is replaced with oxygen delivered from pipes 86 and/or 87. Catalytic converter 80 includes a plurality of catalyst regions or stages 88a-88d that include catalyst suitable for catalytically oxidizing at least portion of the sulfur dioxide-containing feed delivered to catalyst converter by pipe 84. Catalytic converter 80 also includes a plurality of heat exchangers 89a-89c for removing heat energy generated during the oxidation process of sulfur dioxide to sulfur trioxide. Catalytic converter 80 also includes a plurality of pipes 90a-90f for fluidly connecting the plurality of catalytic regions 88a-88d and the plurality of heat exchangers 89a-89c. Catalytic converter 80 further includes a branch 86′ or pipe extending from and in fluid communication with the pipe 86. A plurality of pipes 91a-91c or inlets are in fluid communication with the branch 86′ and the pipes 90a, 90c, 90e, respectively, via orifices 92a-92c, respectively, located in a side wall 93 of the catalytic converter 80. Oxygen-enriched atmospheric oxidizing air and/or pure oxygen is delivered to pipes 90a, 90c, 90e in the housing 81 of the catalytic converter 80 via pipes 91a-91c that extend through the side wall 93 upstream of each of the heat exchangers 89a-89c. The gas stream containing sulfur trioxide exits the catalytic converter 80 at outlet 83 through pipe 94.

According to certain illustrative embodiments herein, there is provided a process for converting sulfur dioxide to sulfur trioxide, which includes (a) introducing a sulfur dioxide feed stream into a catalytic converter for converting sulfur dioxide to sulfur trioxide; (b) introducing an oxygen-enriched feed stream, a pure oxygen feed stream, or both the oxygen-enriched feed stream and the pure oxygen feed stream into the catalytic converter; and (c) catalytically oxidizing at least a portion of the sulfur dioxide from the sulfur dioxide feed stream for producing sulfur trioxide.

Other embodiments of the process include, wherein (b) comprises adding the oxygen-enriched feed stream to the catalytic converter.

Other embodiments of the process include, wherein (b) comprises adding the pure oxygen feed stream to the catalytic converter.

Other embodiments of the process include, wherein (b) comprises adding both the oxygen-enriched feed stream and the pure oxygen feed stream to the catalytic converter.

Other embodiments of the process include, wherein the oxygen-enriched feed stream comprises air.

Other embodiments of the process include, wherein the catalytically oxidizing the at least a portion of the sulfur dioxide from the sulfur dioxide feed stream occurs in at least one catalytic region within the catalytic converter.

Other embodiments of the process further comprise removing heat energy from the sulfur dioxide feed stream with at least one heat exchanger operably co-acting with the sulfur dioxide feed stream.

Other embodiments of the process further comprise catalytically oxidizing the at least a portion of the sulfur dioxide from the sulfur dioxide feed stream in a plurality of catalytic regions within the catalytic converter, and removing heat energy from the sulfur dioxide feed stream with a plurality of heat exchangers operably co-acting with the sulfur dioxide feed stream.

Other embodiments of the process include, wherein catalytically oxidizing at least a portion of the sulfur dioxide occurs in more than one catalytic region and more than one heat exchanger alternately positioned along the catalytic converter. Other embodiments of this process include, wherein (b) comprises introducing the oxygen-enriched feed stream, the pure oxygen feed stream, or both the oxygen-enriched feed stream and the pure oxygen feed stream into the catalytic converter at a position upstream of a first catalytic region of the catalytic converter. Other embodiments of this process include, wherein (b) comprises introducing the oxygen-enriched feed stream, the pure oxygen feed stream, or both the oxygen-enriched feed stream and the pure oxygen feed stream into the catalytic converter at a position upstream of the one or more heat exchangers. Other embodiments of this process include, wherein (b) comprises introducing the oxygen-enriched feed stream, the pure oxygen feed stream, or both the oxygen-enriched feed stream and the pure oxygen feed stream into the catalytic converter at a position downstream of the one or more heat exchangers.

Other embodiments of the process include, wherein the sulfur dioxide feed stream comprises at least one of a spent sulfuric acid stream or the other sulfur-containing stream from a furnace.

According to certain illustrative embodiments herein, there is provided an apparatus for converting sulfur dioxide to sulfur trioxide, which includes a housing; an inlet for the housing for supplying a sulfur dioxide-containing feed into the housing; at least one catalytic region positioned in the housing for converting sulfur dioxide to sulfur trioxide; and at least one inlet for supplying a feed stream of an oxygen-enriched combustion air or a feed stream of pure oxygen into the sulfur dioxide-containing feed.

Other embodiments of the apparatus further comprise at least one heat exchanger in fluid communication with the at least one catalytic region.

Other embodiments of the apparatus include, wherein the inlet is positioned upstream from a first catalytic region of the housing.

Other embodiments of the apparatus include, wherein another inlet is positioned upstream of the at least one heat exchanger.

Other embodiments of the apparatus include, wherein another inlet is positioned downstream of the at least one heat exchanger.

Other embodiments of the apparatus further comprise a decomposition furnace positioned upstream from the housing, the decomposition furnace comprising an outlet for supplying the sulfur dioxide-containing feed from the decomposition furnace to the inlet of the housing.

Other embodiments of the apparatus further comprise a sulfuric acid absorption vessel positioned downstream of the housing for receiving the sulfur trioxide.

Other embodiments of the apparatus include, wherein the at least one heat exchanger is positioned within the housing.

Other embodiments of the apparatus include, wherein a plurality of catalytic regions and a plurality of heat exchangers are positioned within the housing in fluid communication with each other in a successive alternating arrangement.

Other embodiments of the apparatus include, wherein the at least one heat exchanger is positioned external to the housing.

Other embodiments of the apparatus further comprise at least one other inlet (71a-c) for the feed stream of pure oxygen positioned downstream of the at least one heat exchanger.

Other embodiments of the apparatus further comprise at least one other inlet (91a-c) for the feed stream of pure oxygen positioned upstream of the at least one heat exchanger.

It will be understood that the embodiments described herein are merely exemplary, and that a person skilled in the art may make variations and modifications without departing from the spirit and scope of the invention. All such variations and modifications are intended to be included within the scope of the invention provided in the appended claims. It should be understood that the embodiments described above are not only in the alternative but can be combined.

What is claimed is:

1. A process for converting sulfur dioxide to sulfur trioxide, comprising:
(a) introducing a sulfur dioxide feed stream into a catalytic converter for converting sulfur dioxide to sulfur trioxide;
(b) introducing an oxygen-enriched feed stream, a pure oxygen feed stream, or both the oxygen-enriched feed stream and the pure oxygen feed stream into the catalytic converter; and
(c) catalytically oxidizing at least a portion of the sulfur dioxide from the sulfur dioxide feed stream for producing sulfur trioxide.

2. The process of claim 1, wherein (b) comprises adding the oxygen-enriched feed stream to the catalytic converter.

3. The process of claim 1, wherein (b) comprises adding the pure oxygen feed stream to the catalytic converter.

4. The process of claim 1, wherein (b) comprises adding both the oxygen-enriched feed stream and the pure oxygen feed stream to the catalytic converter.

5. The process of claim 1, wherein the oxygen-enriched feed stream comprises air.

6. The process of claim 1, wherein the catalytically oxidizing the at least a portion of the sulfur dioxide from the sulfur dioxide feed stream occurs in at least one catalytic region within the catalytic converter.

7. The process of claim 1, further comprising removing heat energy from the sulfur dioxide feed stream with at least one heat exchanger operably co-acting with the sulfur dioxide feed stream.

8. The process of claim 1, further comprising catalytically oxidizing the at least a portion of the sulfur dioxide from the sulfur dioxide feed stream in a plurality of catalytic regions within the catalytic converter, and removing heat energy from the sulfur dioxide feed stream with a plurality of heat exchangers operably co-acting with the sulfur dioxide feed stream.

9. The process of claim 1, wherein catalytically oxidizing at least a portion of the sulfur dioxide occurs in more than one catalytic region and more than one heat exchanger alternately positioned along the catalytic converter.

10. The process of claim 9, wherein (b) comprises introducing the oxygen-enriched feed stream, the pure oxygen feed stream, or both the oxygen-enriched feed stream and the pure oxygen feed stream into the catalytic converter at a position upstream of a first catalytic region of the catalytic converter.

11. The process of claim 9, wherein (b) comprises introducing the oxygen-enriched feed stream, the pure oxygen feed stream, or both the oxygen-enriched feed stream and the pure oxygen feed stream into the catalytic converter at a position upstream of the one or more heat exchangers.

12. The process of claim 9, wherein (b) comprises introducing the oxygen-enriched feed stream, the pure oxygen feed stream, or both the oxygen-enriched feed stream and the pure oxygen feed stream into the catalytic converter at a position downstream of the one or more heat exchangers.

13. The process of claim 1, wherein the sulfur dioxide feed stream comprises:
at least one of a spent sulfuric acid stream or the other sulfur-containing stream from a furnace.

14. An apparatus for converting sulfur dioxide to sulfur trioxide, comprising
a housing;
an inlet for the housing for supplying a sulfur dioxide-containing feed into the housing;
at least one catalytic region positioned in the housing for converting sulfur dioxide to sulfur trioxide; and
at least one inlet for supplying a feed stream of an oxygen-enriched combustion air or a feed stream of pure oxygen into the sulfur dioxide-containing feed.

15. The apparatus of claim 14, further comprising at least one heat exchanger in fluid communication with the at least one catalytic region.

16. The apparatus of claim 14, wherein the inlet is positioned upstream from a first catalytic region of the housing.

17. The apparatus of claim 15, wherein another inlet is positioned upstream of the at least one heat exchanger.

18. The apparatus of claim 15, wherein another inlet is positioned downstream of the at least one heat exchanger.

19. The apparatus of claim 14, further comprising a decomposition furnace positioned upstream from the housing, the decomposition furnace comprising an outlet for supplying the sulfur dioxide-containing feed from the decomposition furnace to the inlet of the housing.

20. The apparatus of claim 14, further comprising a sulfuric acid absorption vessel positioned downstream of the housing for receiving the sulfur trioxide.

21. The apparatus of claim 15, wherein the at least one heat exchanger is positioned within the housing.

22. The apparatus of claim 15, wherein the at least one heat exchanger is positioned external to the housing.

23. The apparatus of claim 14, wherein a plurality of catalytic regions and a plurality of heat exchangers are positioned within the housing in fluid communication with each other in a successive alternating arrangement.

24. The apparatus of claim 15, further comprising at least one other inlet (71a-c) for the feed stream of pure oxygen positioned downstream of the at least one heat exchanger.

25. The apparatus of claim 15, further comprising at least one other inlet (91a-c) for the feed stream of pure oxygen positioned upstream of the at least one heat exchanger.
